(19) United States
(12) Patent Application Publication
(10) Pub. No.: US 2017/0365061 A1
(43) Pub. Date: Dec. 21, 2017

(54) IMAGE RECOGNITION METHOD AND APPARATUS

(71) Applicant: Alibaba Group Holding Limited, Grand Cayman (KY)

(72) Inventors: Shiyao Xiong, Hangzhou (CN); Wenfei Jiang, Hangzhou (CN); Kaiyan Chu, Hangzhou (CN)

(21) Appl. No.: 15/623,746

(22) Filed: Jun. 15, 2017

(30) Foreign Application Priority Data
Jun. 16, 2016 (CN) 201610430736.1

(51) Int. Cl. G06T 7/13; G06T 7/60; G06K 9/46

(52) U.S. Cl. CPC G06T 7/13; G06K 9/4604; G06T 7/60

(57) ABSTRACT

An image recognition method is disclosed. The method includes acquiring an image detecting image information and a position of a polygon object included in the image; projecting the image information of the polygon object onto the recognition area based on the position of the polygon object and a position of a recognition area to obtain a projection image; and recognizing the projection image using an image recognition technology to obtain information in the polygon object. Projecting image information of a polygon object onto a recognition area and performing recognition thereon are equivalent to correcting a shape and a position of the polygon object in the recognition area, such that an image after the correction can be recognized. As such, a failure in recognition due to a failure of a position, a shape and the like of a polygon object in a recognition area in fulfilling the recognition requirements is solved.

### CROSS REFERENCE TO RELATED PATENT APPLICATION

This application claims foreign priority to Chinese Patent Application No. 201610430736.1 filed on Jun. 16, 2016, entitled “Image Recognition Method and Apparatus”, which is hereby incorporated by reference in its entirety.

### TECHNICAL FIELD

The present disclosure relates to the field of image processing, and in particular, to image recognition methods and apparatuses.

### BACKGROUND

With the continuous development of image recognition technologies, performing image recognition on a polygon object to obtain textual content and other information displayed in the polygon object has been widely used. For example, by recognizing a rectangular card such as a bank card, card number and other textual content of the rectangular card can be recognized.

At present, when image recognition is performed on a polygon object, an image recognition technology such as Optical Character Recognition (OCR) is mainly employed. However, when information displayed in the polygon object is recognized by the technology such as OCR, certain requirements on a shape, a position and the like of the polygon object in a recognition area exist, or a failure in recognition may be resulted. For example, for a rectangular card, if the position of the card is in the recognition area as shown in FIG. 1, recognition can be successful, If the position of the card is in the recognition area as shown in FIG. 2, i.e., when the shape of the rectangular card is suffered from a perspective distortion due to a shooting angle, the textual content cannot be recognized by the OCR technology, for example.

Therefore, a failure in recognition caused by an inconformity of a position, a shape and the like of a polygon object in a recognition area with respect to recognition requirements is needed to be solved nowadays.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

A technical problem to be solved by the present disclosure is to provide an image recognition method and an apparatus thereof that project a polygon object onto a recognition area, to solve a recognition failure due to an inconformity of a position, a shape and the like of a polygon object in a recognition area with respect to recognition requirements.

Accordingly, a technical solution of the present disclosure is provided herein.

In implementations, the present disclosure provides an image recognition method. The method may include acquiring an image to be recognized, the image to be recognized having a polygon object; detecting image information and a position of the polygon object; projecting the image information of the polygon object onto a recognition area to obtain a projection image based on the position of the polygon object and a position of the recognition area; and recognizing the projection image to obtain information in the polygon object using an image recognition technology.

In implementations, detecting the position of the polygon object may include detecting positions of vertices of the polygon object.

In implementations, projecting the image information of the polygon object onto the recognition area to obtain the projection image based on the position of the polygon object and the position of the recognition area may include generating a projection matrix from the polygon object to the recognition area based on the positions of the vertices of the polygon object and positions of vertices of the recognition area; and projecting the image information of the polygon object onto the recognition area to obtain the projection image according to the projection matrix.

In implementations, detecting the positions of vertices of the polygon object may include performing edge detection on the image to be recognized to detect edges of the polygon object; detecting straight edges from the edges of the polygon object; and determining the positions of the vertices of the polygon object based on the straight edges.

In implementations, before projecting the image information of the polygon object onto the recognition area, the method may further include detecting whether the polygon object is an N-polygon, and projecting the image information of the polygon object onto the recognition area if affirmative, wherein N is a sum of a number of straight edges of the recognition area.

In implementations, the polygon object is an object obtained after an original object is deformed. The projection image is a rectification image of the image to be recognized, the rectification image having the original object after correction.

In implementations, recognizing the projection image to obtain information in the polygon object using the image recognition technology may include recognizing the rectification image to obtain information in the original object using the image recognition technology.

In implementations, acquiring the image to be recognized may include displaying one or more images to a user, and acquiring an image selected by the user from the one or more displayed images to serve as the image to be recognized; or acquiring an image collected by an image collection device to serve as the image to be recognized.

In implementations, before acquiring the image to be recognized, the method may further include determining that recognition performed on the image to be recognized using the image recognition technology fails.

In implementations, the present disclosure further provides an image recognition apparatus. The apparatus may include an acquisition unit configured to acquire an image to be recognized, the image to be recognized having a polygon object; a detection unit configured to detect image information and a position of the polygon object; a projection unit configured to project the image information of the polygon object onto a recognition area to obtain a projection image based on the position of the polygon object and a position of the recognition area; and a recognition unit configured to recognize the projection image to obtain information in the polygon object using an image recognition technology.

In implementations, when the detection unit detects the position of the polygon object, the detection unit may detect positions of vertices of the polygon object.

In implementations, the projection unit may further generate a projection matrix from the polygon object to the recognition area based on the positions of the vertices of the polygon object and positions of vertices in the recognition area, and project the image information of the polygon object onto the recognition area to obtain the projection image according to the projection matrix.

In implementations, when the detection unit detects the positions of the vertices in the polygon object, the detection unit may further perform edge detection on the image to be recognized to detect edges of the polygon object, detect straight edges from the edges of the polygon object, and determine the positions of the vertices of the polygon object based on the straight edges.

In implementations, the detection unit may further detect whether the polygon object is an N-polygon, and notify the projection unit to project the image information of the polygon object onto the recognition area if affirmative, wherein N is a sum of a number of straight edges of the recognition area.

In implementations, the polygon object is an object obtained after an original object is deformed. The projection image is a rectification image of the image to be recognized, the rectification image having the original object after correction.

In implementations, the recognition unit may further recognize the rectification image to obtain information in the original object using the image recognition technology.

In implementations, when the acquisition unit acquires the image to be recognized, the acquisition unit may further display one or more images to a user through a display unit, and acquire an image selected by the user from the one or more displayed images to serve as the image to be recognized, or acquire an image collected by an image collection device to serve as the image to be recognized.

In implementations, the image recognition apparatus may further include a determination unit configured to determine that recognition performed on the image to be recognized using the image recognition technology fails before the acquisition unit acquires the image to be recognized.

As can be seen from the above technical solutions, with an image to be recognized including a polygon object, the disclosed method and apparatus detect image information and a position of the polygon object, and project the image information of the polygon object onto a recognition area to obtain a projection image based on a position of the polygon object and a position of a recognition area, thereby recognizing the projection image and using an image recognition technology to obtain information displayed in the polygon object. As can be seen, the disclosed method and apparatus do not directly recognize the image to be recognized, but perform recognition after the image information of the polygon object is projected onto the recognition area, which is equivalent to correcting the shape and the position of the polygon object in the recognition area, such that the corrected image, i.e., the projection image, can be recognized. As such, a failure in recognition due to a failure of a position, a shape and the like of a polygon object in a recognition area in fulfilling the recognition requirements is solved.

### BRIEF DESCRIPTION OF THE DRAWINGS

In order to describe the technical solutions in the embodiments of the present disclosure more clearly, accompanying drawings to be used in the description of the embodiments are briefly described hereinafter. Apparently, these accompanying drawings represent merely some embodiments of the present disclosure. One of ordinary skill in the art can also obtain other accompanying drawings based on these accompanying drawings of the present disclosure.

FIG. 1 is a schematic diagram of a position of a rectangular card in a recognition area.

FIG. 2 is a schematic diagram of another position of a rectangular card in a recognition area.

FIG. 3 is a flowchart of an example method according to the present disclosure.

FIG. 4 is a flowchart of another example method according to the present disclosure.

FIG. 5 is a schematic diagram after edge detection is performed on an image to be recognized.

FIG. 6 is a schematic diagram of detecting a vertex in an image to be recognized.

FIG. 7 is a schematic diagram of textual content obtained after recognition performed on a projection image.

FIG. 8 is a structural diagram of an example apparatus according to the present disclosure.

### DETAILED DESCRIPTION

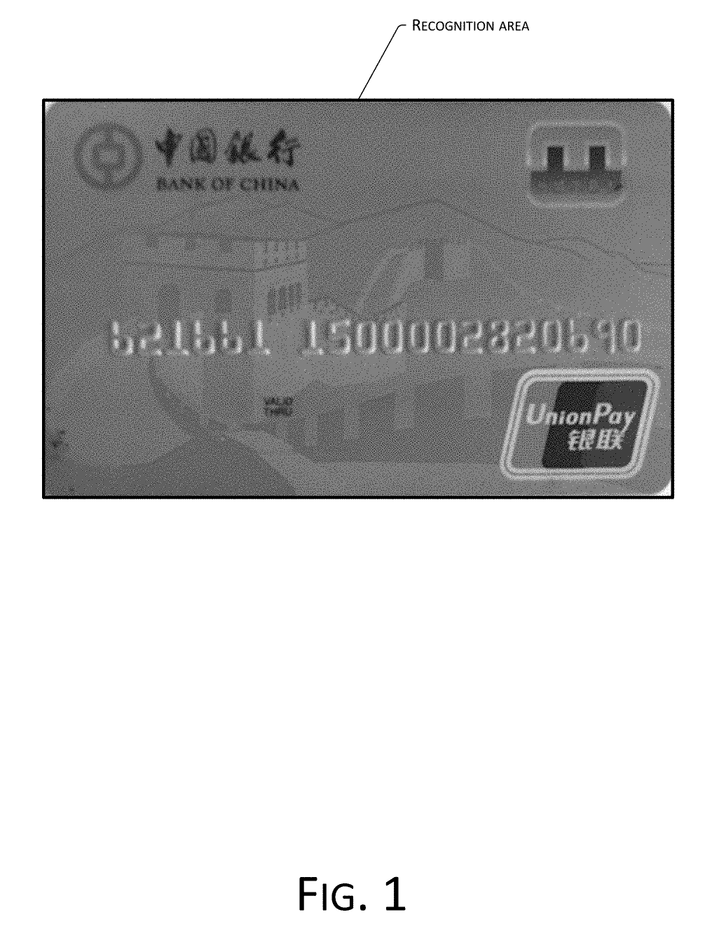

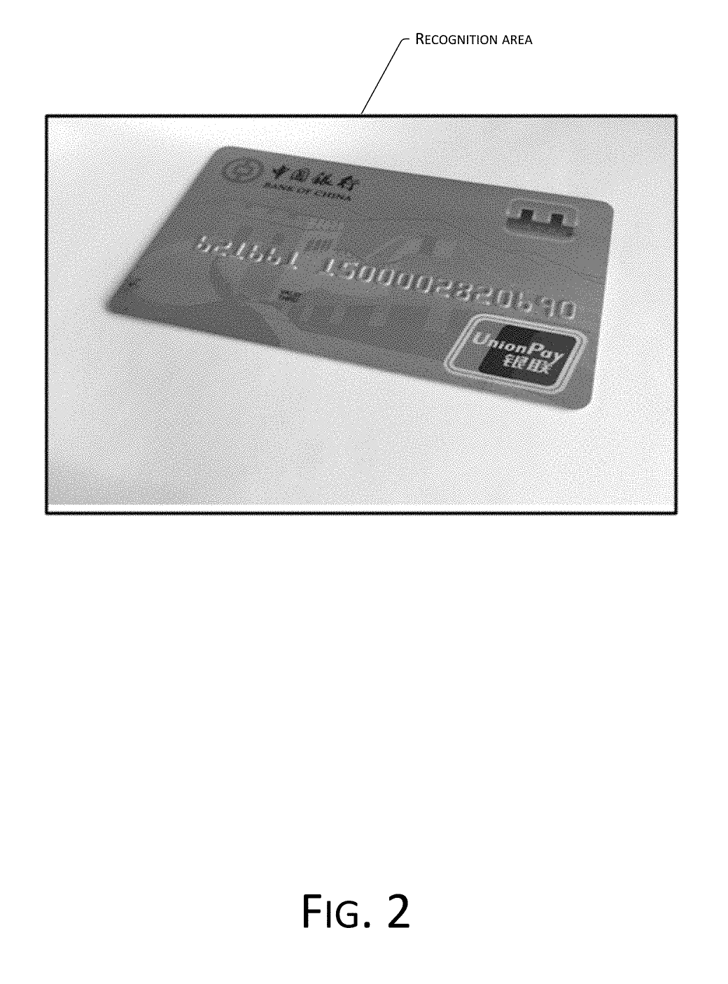

When textual content and other information included in a polygon object is recognized by using technologies such as OCR, a corresponding piece of information is generally recognized based on a particular position in a recognition area. Therefore, certain requirements on a shape, a position and the like of a polygon object in a recognition area exist. Examples of these requirements may include the polygon object being located at the center of the recognition area, or the shape of the polygon object being not distorted. Otherwise, a failure in recognition is resulted. For example, for a rectangular card, if the card is positioned in the recognition area as shown in FIG. 1, recognition can be successful. If the card is positioned in the recognition area as shown in FIG. 2, i.e., when the shape of the rectangular card is suffered from a perspective distortion due to a shooting angle, textual content displayed on the rectangular card may not be recognized by the OCR technology, for example. Therefore, a recognition failure caused by a failure of a position, a shape and the like of a polygon object in a recognition area in fulfilling the recognition requirements needs to be resolved nowadays.

The present disclosure provides an image recognition method and an image recognition apparatus, which project a polygon object onto a recognition area to achieve corrections of a shape and a position of the polygon object, such that an image after correction can be recognized, thereby resolving the recognition failure due to the failure of the position, the shape and the like of the polygon object in the recognition area to fulfill the recognition requirements.

To enable one skilled in the art to understand the technical solutions in the present disclosure in a better manner, the technical solutions in the embodiments of the present disclosure are clearly and completely described hereinafter with reference to the accompanying drawings of the embodiments of the present disclosure. Apparently, the described embodiments represent merely a portion, and not all, of the embodiments of the present disclosure. All other embodiments obtained by one of ordinary skill in the art based on the embodiments in the present disclosure without making any creative effort shall fall under the scope of protection of the present disclosure.

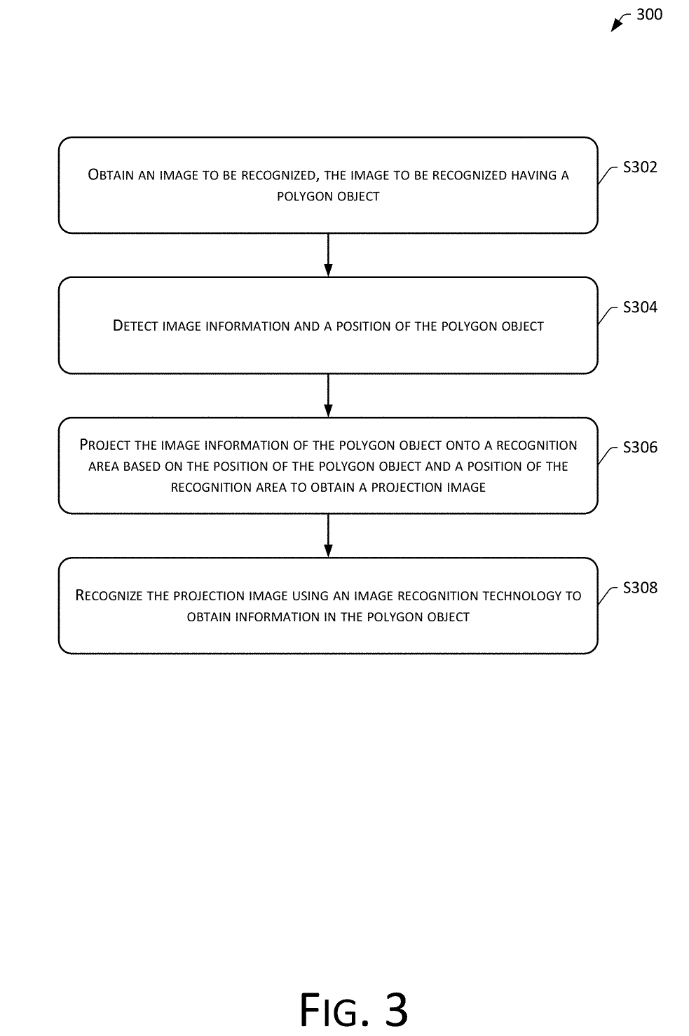

Referring to FIG. 3, the present disclosure provides an exemplary image recognition method 300. In implementations, the method 300 may include the following operations.

S302 obtains an image to be recognized, the image to be recognized having a polygon object (i.e., a polygon object is displayed).

In implementations, recognition may not be performed directly on an image to be recognized. A shape and a position of a polygon object in a recognition area may not be in line with corresponding requirements of an image recognition technology such as OCR. In implementations, the image to be recognized may be an image in the recognition area. For example, the image to be recognized is an image in a rectangular area, and the polygon object is a rectangular card, as shown in FIG. 2. An image recognition technology such as OCR is not able to recognize the text content in the rectangular card directly.

In implementations, the recognition area refers to a particular area for recognizing information such as textual content, for example. In other words, what is recognized in a process of recognition is information in the recognition area. For example, areas in rectangular boxes respectively in FIG. 1 and FIG. 2 are recognition areas, and respective pieces of textual content in the rectangular boxes are what to be recognized. In the implementations, the polygon object refers to an object having at least three edges, which includes, for example, an object of a triangular shape, a rectangular shape, or a trapezoidal shape, etc.

S304 detects image information and a position of the polygon object.

In implementations, the image information of the polygon object refers to information that is capable of reflecting image features of the polygon object, which may include an image matrix (e.g., a grayscale value matrix), etc., of the polygon object, for example. In implementations, the polygon object may be extracted from the image to be recognized by performing edge detection on the image to be recognized.

In implementations, the position of the polygon object may include positions of the polygon object at multiple particular points, for example, positions of vertices of the polygon object.

S306 projects the image information of the polygon object onto the recognition area based on the position of the polygon object and a position of a recognition area to obtain a projection image.

If the position of the polygon object in the recognition area fails to fulfill one or more particular requirements, an image recognition technology such as OCR may not be able to recognize the polygon object directly. Accordingly, in implementations, the image information of the polygon object is projected onto the recognition area to obtain a projection image, by using the position of the polygon object and a position of a recognition area. This is equivalent to correcting a shape, a position, etc., of the polygon object, such that an image after the correction, i.e., the projection image, can be recognized. By way of example and not limitation, the image matrix of the rectangular card may be projected onto the recognition area to obtain a projection image as shown in FIG. 1, by using the position of the recognition area and the position of the rectangular card as shown in FIG. 2.

In implementations, the position of the recognition area may include positions of the recognition area at multiple particular points, for example, positions of vertices of the recognition area. In implementations, edges of the recognition area may be visible, as shown in FIG. 2, or may be hidden and invisible and are set by an apparatus internally.

In implementations, a real shape of the polygon object and a shape of the recognition area are generally consistent with each other, for example, both are rectangular as shown in FIG. 2. The rectangular card in FIG. 2 is, however, suffered from a perspective distortion due to a shooting angle. Therefore, in implementations, at least a condition that a number of straight edges of the polygon object and a number of straight edges of the recognition area are the same needs to be fulfilled.

S308 recognizes the projection image using an image recognition technology to obtain information included in the polygon object.

In implementations, the information includes digital information such as textual content, image content, etc.

As the image information of the polygon object has been projected onto the recognition area, a projection image obtained after the projection can satisfy the one or more requirements of an image recognition technology such as OCR in terms of the shape, the position, etc., of the polygon object in the recognition area. Therefore, the image recognition technology such as OCR is able to recognize the projection image. For example, OCR may be used to recognize the projection image as shown in FIG. 1, and textual content such as a card number in the rectangular card can be recognized.

In implementations, the embodiments of the present disclosure can be applied to notebooks, tablet computers, mobile phones and other electronic devices.

As can be seen from the above technical solutions, with an image to be recognized including a polygon object, the disclosed method detects image information and a position of the polygon object, and projects the image information of the polygon object onto a recognition area to obtain a projection image based on a position of the polygon object and a position of a recognition area, thereby recognizing the projection image and using an image recognition technology to obtain information displayed in the polygon object. As can be seen, the disclosed method does not directly recognize the image to be recognized, but performs recognition after the image information of the polygon object is projected onto the recognition area, which is equivalent to correcting the shape and the position of the polygon object in the recognition area, such that the corrected image, i.e., the projection image, can be recognized. As such, a failure in recognition due to a failure of a position, a shape and the like of a polygon object in a recognition area in fulfilling the recognition requirements is solved.

In implementations, the polygon object may be an object after an original object is deformed. For example, the original object may be the rectangular card as shown in FIG. 1, and the polygon object may be the deformed rectangular card as shown in FIG. 2. Therefore, the projection image obtained at S306 is actually a rectification image of the image to be recognized, and the rectification image includes the original object after correction. In implementations, S308 may include recognizing the rectification image using the image recognition technology to obtain information in the original object.

After S302 is performed, i.e., after the image to be recognized is acquired, a determination may be made as to whether the image to be recognized is successfully recognized by the image recognition technology such as OCR. If not (i.e., recognition performed on the image to be recognized using the image recognition technology is determined to be failed), S304 is resumed. If affirmative, this indicates that projecting the image to be recognized is not needed, and the image to be recognized can be recognized directly to obtain information in the polygon object.

In implementations, the image to be recognized may be an image collected by an image collection device. For example, an image may be scanned or collected by an image capturing device, such as a camera, of a user terminal, and the scanned image is taken as the image to be recognized.

In addition, in a process of displaying a photo or video to a user, a need of recognizing a polygon object therein may exist. However, the polygon object in the photo or video may fail to fulfill recognition requirements, and technologies of recognizing a polygon object in a photo or video do not exist nowadays. The embodiments of the present disclosure are particularly suitable for recognizing a polygon object in a photo or video. In implementations, the method 300 may further include displaying one or more images to a user, and acquiring an image selected by the user from the one or more displayed images to serve as the image to be recognized. For example, in a process of playing a video to a user, the user may press down a pause key, and select a portion from a currently displayed image as the image to be recognized. The selected image may be an image inside a selection frame, and the selection frame may be taken as the recognition area.

In implementations, when the real shape of the polygon object is consistent with the shape of the recognition area, the polygon object can be projected onto the recognition area. Therefore, before S306 is performed, a determination as to whether the polygon object is an N-polygon may further be made. If affirmative, S306 is performed. In implementations, N is a sum of a number of straight edges of the recognition area. For example, if the recognition area is a rectangle, N is four. Accordingly, before S306 is performed, a determination as to whether the polygon object is a quadrangle is made. If affirmative, S306 is performed. If not, this indicates that the polygon object may not be able to be projected onto the recognition area, and thus the process can be directly ended.

At S306, the polygon object is projected. In implementations, a projection method may include generating a projection matrix from the polygon object to the recognition area based on positions of vertices of the polygon object and positions of vertices of the recognition area, and projecting the image information of the polygon object onto the recognition area according to the projection matrix. This projection method is merely exemplary, and should not be construed as a limitation to the present disclosure. Details of description are provided as follows.

S304 may include detecting image information of the polygon object and positions of vertices, wherein the image information may be an image matrix, e.g., a grayscale value matrix. In implementations, edge detection may be performed on the image to be recognized to detect edges of the polygon object, straight edges may be determined from the edges. Positions of intersection points of the straight edges, which is served as the positions of the vertices in the polygon object, may be determined based on the determined straight edges.

S306 may include generating a projection matrix from the polygon object to the recognition area based on the positions of the vertices in the polygon object and positions of vertices in the recognition area, and projecting the image information of the polygon object onto the recognition area to obtain the projection image according to the projection matrix.

An exemplary recognition method of the present disclosure is described hereinafter using a specific example.

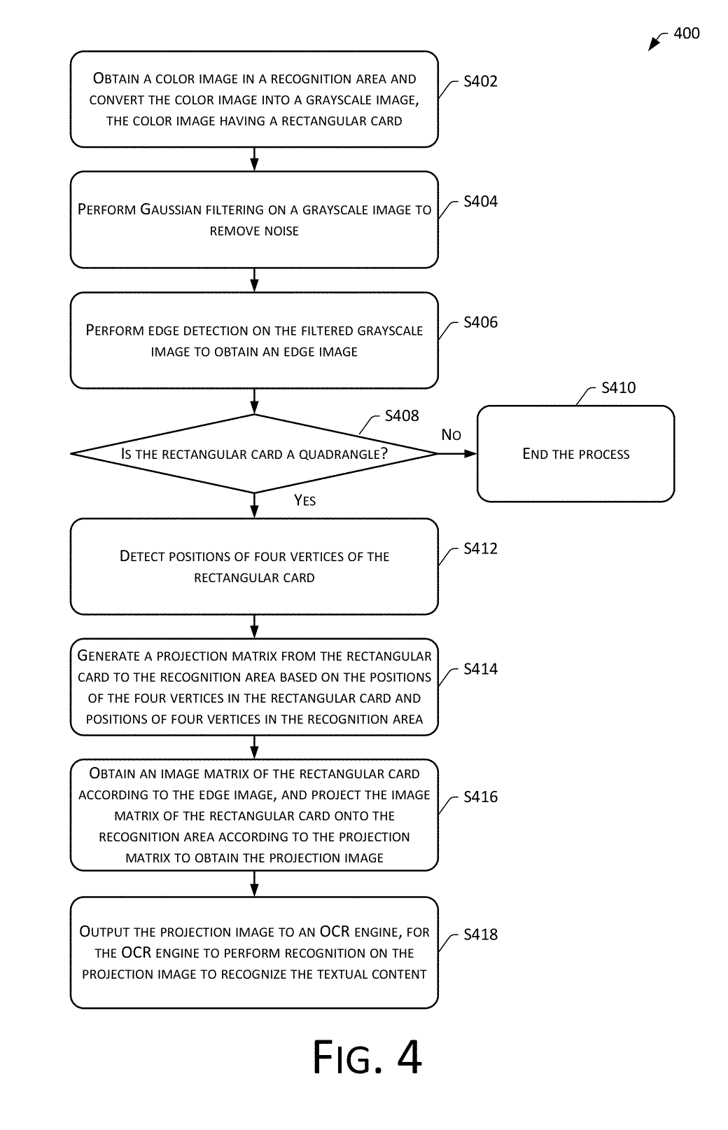

Referring to FIG. 4, the present disclosure provides another image recognition method 400. This embodiment is illustrated by taking the image to be recognized in FIG. 2 as an example.

In implementations, the method 400 may include the following operations.

S402 obtains a color image in a recognition area, the color image having a rectangular card. The color image may be converted into a grayscale image as shown in FIG. 2. In this example, the recognition area is an area in a rectangular block as shown in FIG. 2.

S404 performs Gaussian filtering on the grayscale image to remove noise. A Gaussian filtering formula may be:

S=G*I;

where I is an image matrix of a grayscale image before filtering, G is a filter coefficient matrix, S is an image matrix of the grayscale image after filtering, and * represents a convolution operation.

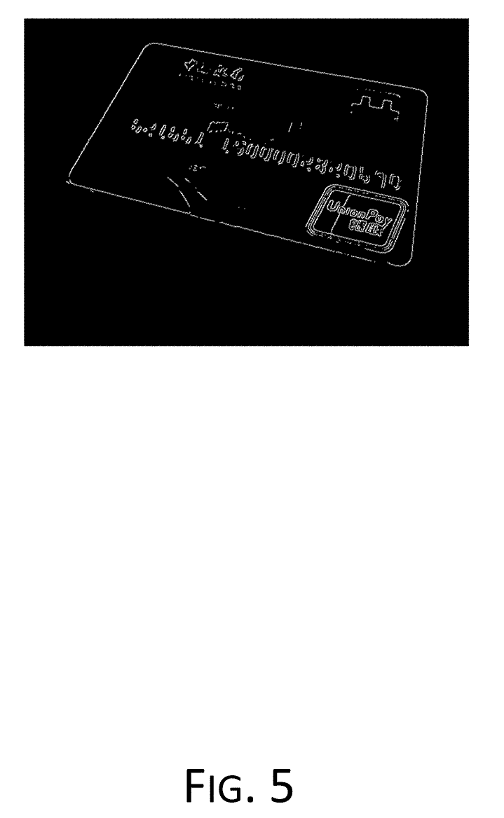

S406 performs edge detection on the filtered grayscale image to obtain an edge image as shown in FIG. 5, the edge image including edges of a rectangular card.

In implementations, the edge detection may include a process as follows.

S4061 calculates partial derivative matrixes P and Q of the filtered grayscale image in two directions which are perpendicular to each other using a finite difference algorithm of first-order partial derivatives.

For example, a corresponding value P[i,j] of the partial derivative matrix P at the coordinate value (i,j) and a corresponding value Q[i,j] of the partial derivative matrix Q at the coordinate value (i,j) may respectively be:

P[i,j]=(S[i,j+1]−S[i,j]+S[i+1,j+1]−S[i+1,j])/2

Q[i,j]=(S[i,j]−S[i+1,j]+S[i,j+1]−S[i+1,j+1])/2

wherein S[x, y] is a corresponding value of an image matrix S of a grayscale image at a coordinate value (x,y), x may be i,i+1, etc., and y may be j, j+1, etc.

S4062 calculates an amplitude matrix M and a direction angle matrix θ according to the partial derivative matrixes.

M[i,j]=\sqrt{P[i,j]²+Q[i,j]²}

θ[i,j]=arctan(Q[i,j]/P[i,j])

where M[i,j] is a corresponding value of the amplitude matrix M at the coordinate value (i,j), and θ[i,j] is a corresponding value of the direction angle matrix θ at the coordinate value (i,j).

S4063 performs non-maximum suppression (NMS) on the amplitude matrix M, i.e., refines ridge bands of the amplitude matrix M by suppressing amplitudes of all non-ridge peaks on a gradient line, thus only keeping a point having an amplitude that has the greatest local change. A range of change of the direction angle matrix θ is reduced to one of four sectors of a circumference, with a central angle of each sector being 90°.

An amplitude matrix N after non-maximum suppression and a direction angle matrix ζ after change are:

ζ[i,j]=Sector(θ[i,j])

N[i,j]=NMS(M[i,j],ζ[i,j])

wherein ζ[i,j] is a corresponding value of the direction angle matrix ζ at the coordinate value (i,j), N[i,j] is a corresponding value of the amplitude matrix N at the coordinate value (i,j), Sector function is used for reducing the range of change of the direction angle matrix to one of four sectors of a circumference, and NMS function is used for performing non-maximum suppression.

S4064 performs detection using a double-threshold algorithm, the amplitude matrix N and the direction angle matrix ζ, to perform edge detection to obtain an edge image as shown in FIG. 5.

S408 detects whether the rectangular card is a quadrangle, and proceeds to S412 if affirmative, or proceeds to S410 otherwise.

In implementations, detecting whether the rectangular card is a quadrangle may include a process as follows.

S4081 detects straight edges using Probabilistic Hough Transform.

Standard Hough Transform maps an image onto a parameter space in essence, which needs to calculate all edge points, thus requiring a large amount of computation cost and a large amount of desired memory space. If only a few edge points are processed, a selection of these edge points is probabilistic, and thus a method thereof is referred to as Probabilistic Hough Transform. This method also has an important characteristic of being capable of detecting line ends, i.e., being able to detect two end points of a straight line in an image, to precisely position the straight line in the image. As an example of implementation, a HoughLinesP function in a Vision Library OpenCV may be used.

A process of detection may include the following operations.

Operation A selects a feature point randomly from the edge image as shown in FIG. 5, and if this point has been calibrated as a point on a straight line, selects a feature point continuously from remaining points in the edge image, till all points in the edge image are selected.

Operation B performs Hough Transform on the feature points selected at operation A, and accumulates the number of straight lines intersecting at a same point in a Hough space.

Operation C selects a point having a value (which indicates the number of straight lines intersecting at a same point) that is the maximum in the Hough space, and performs operation D if this point is greater than a first threshold, or returns to operation A otherwise.

Operation D determines a point corresponding to the maximum value obtained through the Hough Transform, and moves from the point along a direction of a straight line, so as to find two end points of the straight line.

Operation E calculates the length of the straight line found at operation D, and outputs related information of the straight line and returns to operation A if the length is greater than a second threshold.

S410 ends the process.

S412 detects positions of four vertices of the rectangular card.

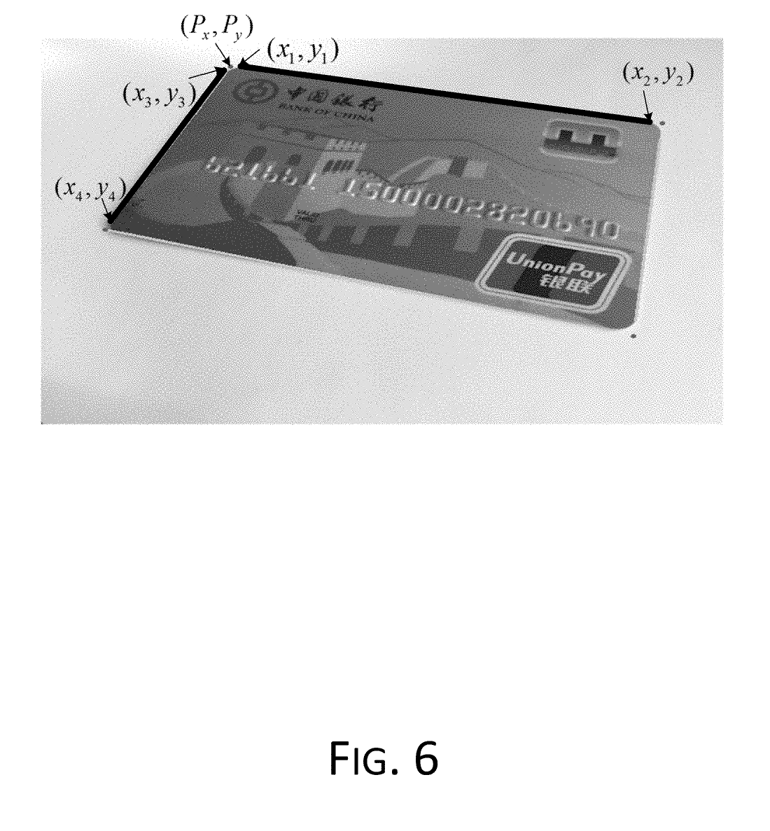

For example, as shown in FIG. 6, coordinates of end points of any two edges are detected to be (x₁, y₁), (x₂, y₂), (x₃, y₃), and (x₄, y₄) respectively. A coordinate (Pₓ, P_{y}) of a vertex at which the two edges intersect can be calculated according to these four coordinates.

$$( {P}_{x} , {P}_{y} ) = [ \begin{matrix}\frac{( {x}_{1} {y}_{2} - {y}_{1} {x}_{2} ) ( {x}_{3} - {x}_{4} ) - ( {x}_{3} {y}_{4} - {y}_{3} {x}_{4} ) ( {x}_{1} - {x}_{2} )}{( {x}_{1} - {x}_{2} ) ( {y}_{3} - {y}_{4} ) - ( {y}_{1} - {y}_{2} ) ( {x}_{3} - {x}_{4} )} , \\ \frac{( {x}_{1} {y}_{2} - {y}_{1} {x}_{2} ) ( {y}_{3} - {y}_{4} ) - ( {y}_{1} - {y}_{2} ) ( {x}_{3} {y}_{4} - {y}_{3} {x}_{4} )}{( {x}_{1} - {x}_{2} ) ( {y}_{3} - {y}_{4} ) - ( {y}_{1} - {y}_{2} ) ( {x}_{3} - {x}_{4} )}\end{matrix} ]$$

S414 generates a projection matrix from the rectangular card to the recognition area based on the positions of the four vertices in the rectangular card and positions of four vertices in the recognition area.

In implementations, a process of acquiring the projection matrix A may include:

A projection matrix A is:

$$[ \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ]$$

A conversion relation between a coordinate (u′,v′) after projection and a coordinate (u,v) before projection is:

$${u}^{′} = \frac{{a}_{11} u + {a}_{21} v + {a}_{31}}{{a}_{13} u + {a}_{23} v + {a}_{33}} ;$$

$${v}^{′} = \frac{{a}_{12} u + {a}_{22} v + {a}_{32}}{{a}_{13} u + {a}_{23} v + {a}_{33}} ;$$

Therefore, the projection matrix A can be calculated by substituting the positions of the four vertices of the rectangular card into (u,v) and substituting positions of four vertices of the projection area into (u′,v′).

S416 obtains an image matrix of the rectangular card according to the edge image as shown in FIG. 5, and projects the image matrix of the rectangular card onto the recognition area according to the projection matrix to obtain the projection image as shown in FIG. 1.

For example, after the projection matrix A is obtained, the image matrix after projection can be obtained using the conversion relationship between the coordinate (u′,v′) after the projection and the coordinate (u,v) before the projection and by substituting the image matrix of the rectangular card into (u,v).

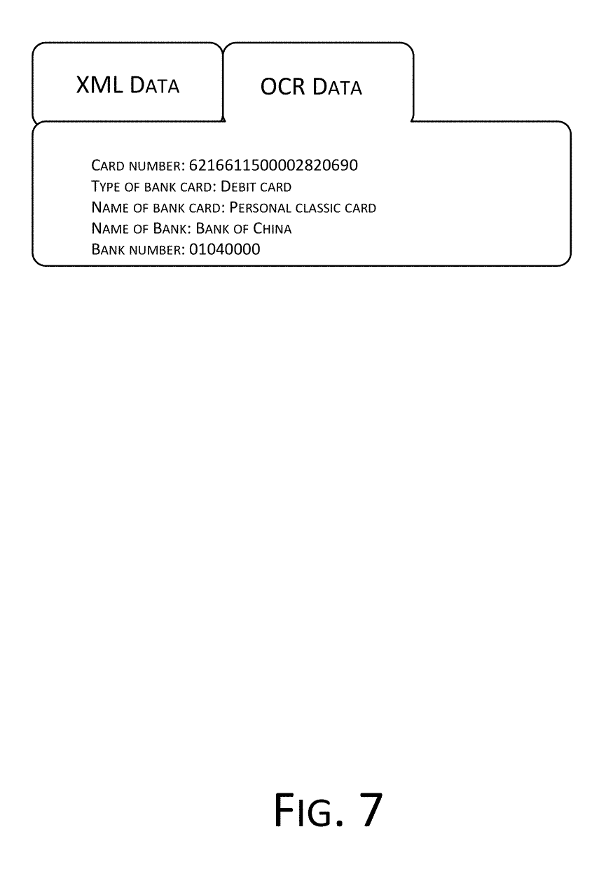

S418 outputs the projection image to an OCR engine, for the OCR engine to perform recognition on the projection image to recognize the textual content as shown in FIG. 7.

Corresponding to the foregoing method embodiment, the present disclosure further provides an apparatus embodiment of a corresponding image recognition apparatus.

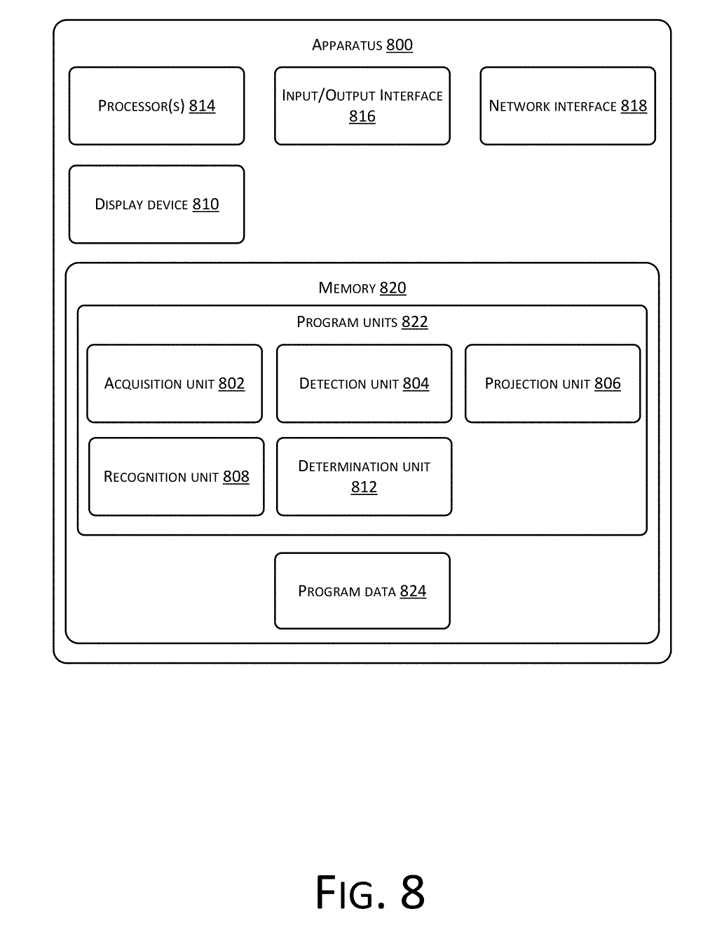

Referring to FIG. 8, the present disclosure provides an apparatus embodiment of an image recognition apparatus 800. In implementations, the apparatus 800 may include an acquisition unit 802, a detection unit 804, a projection unit 806, and a recognition unit 808.

The acquisition unit 802 may acquire an image to be recognized, the image to be recognized having a polygon object.

In implementations, recognition may not be performed directly on an image to be recognized. A shape and a position of a polygon object in a recognition area may not be in line with corresponding requirements of an image recognition technology such as OCR. In implementations, the image to be recognized may be an image in the recognition area. For example, the image to be recognized is an image in a rectangular area, and the polygon object is a rectangular card, as shown in FIG. 2. An image recognition technology such as OCR is not able to recognize the text content in the rectangular card directly.

In implementations, the recognition area refers to a particular area for recognizing information such as textual content, for example. In other words, what is recognized in a process of recognition is information in the recognition area. For example, areas in rectangular boxes respectively in FIG. 1 and FIG. 2 are recognition areas, and respective pieces of textual content in the rectangular boxes are what to be recognized. In the implementations, the polygon object refers to an object having at least three edges, which includes, for example, an object of a triangular shape, a rectangular shape, or a trapezoidal shape, etc.

The detection unit 804 may detect image information and a position of the polygon object.

In implementations, the image information of the polygon object refers to information that is capable of reflecting image features of the polygon object, which may include an image matrix (e.g., a grayscale value matrix), etc., of the polygon object, for example. In implementations, the polygon object may be extracted from the image to be recognized by performing edge detection on the image to be recognized.

In implementations, the position of the polygon object may include positions of the polygon object at multiple particular points, for example, positions of vertices of the polygon object.

The projection unit 806 may project the image information of the polygon object onto the recognition area based on the position of the polygon object and a position of a recognition area to obtain a projection image.

If the position of the polygon object in the recognition area fails to fulfill one or more particular requirements, an image recognition technology such as OCR may not be able to recognize the polygon object directly. Accordingly, in implementations, the image information of the polygon object is projected onto the recognition area to obtain a projection image, by using the position of the polygon object and a position of a recognition area. This is equivalent to correcting a shape, a position, etc., of the polygon object, such that an image after the correction, i.e., the projection image, can be recognized. By way of example and not limitation, the image matrix of the rectangular card may be projected onto the recognition area to obtain a projection image as shown in FIG. 1, by using the position of the recognition area and the position of the rectangular card as shown in FIG. 2.

In implementations, the position of the recognition area may include positions of the recognition area at multiple particular points, for example, positions of vertices of the recognition area. In implementations, edges of the recognition area may be visible, as shown in FIG. 2, or may be hidden and invisible and are set by an apparatus internally.

In implementations, a real shape of the polygon object and a shape of the recognition area are generally consistent with each other, for example, both are rectangular as shown in FIG. 2. The rectangular card in FIG. 2 is, however, suffered from a perspective distortion due to a shooting angle. Therefore, in implementations, at least a condition that a number of straight edges of the polygon object and a number of straight edges of the recognition area are the same needs to be fulfilled.

The recognition unit 808 may recognize the projection image using an image recognition technology to obtain information in the polygon object.

In implementations, the information includes digital information such as textual content, image content, etc.

As the image information of the polygon object has been projected onto the recognition area, a projection image obtained after the projection can satisfy the one or more requirements of an image recognition technology such as OCR in terms of the shape, the position, etc., of the polygon object in the recognition area. Therefore, the image recognition technology such as OCR is able to recognize the projection image. For example, OCR may be used to recognize the projection image as shown in FIG. 1, and textual content such as a card number in the rectangular card can be recognized.

In implementations, the embodiments of the present disclosure can be applied to notebooks, tablet computers, mobile phones and other electronic devices.

In implementations, when the position of the polygon object is detected, the detection unit 804 may detect positions of vertices of the polygon object.

In implementations, the projection unit 806 may further generate a projection matrix from the polygon object to the recognition area based on the positions of the vertices in the polygon object and positions of vertices in the recognition area, and project the image information of the polygon object onto the recognition area according to the projection matrix to obtain the projection image.

In implementations, when detecting the positions of vertices in the polygon object, the detection unit 804 may further perform edge detection on the image to be recognized to detect edges of the polygon object, detect straight edges from the edges of the polygon object, and determine the positions of the vertices in the polygon object based on the straight edges.

In implementations, before the projection unit 806 projects the image information of the polygon object onto the recognition area, the detection unit 804 may further detect whether the polygon object is an N-polygon, and notify the projection unit 806 to project the image information of the polygon object onto the recognition area if affirmative, where N is a sum of a number of straight edges of the recognition area.

In implementations, the polygon object is an object obtained after an original object is deformed. The projection image is a rectification image of the image to be recognized, the rectification image having the original object after correction.

In implementations, the recognition unit 808 may recognize the rectification image using an image recognition technology to obtain information in the original object.

In implementations, when acquiring the image to be recognized, the acquisition unit 802 may further display one or more images to a user through a display unit or device 810, and acquire an image selected by the user to serve as the image to be recognized from the one or more displayed images, or obtain an image collected by an image collection device to serve as the image to be recognized.

In implementations, the apparatus 800 may further include a determination unit 812 to determine that recognition performed on the image to be recognized using the image recognition technology fails, before the acquisition unit 802 acquires the image to be recognized.

In implementations, the apparatus 800 may further include one or more processors 814, an input/output (I/O) interface 816, a network interface 818, and memory 820.

The memory 820 may include a form of computer-readable media, e.g., a non-permanent storage device, random-access memory (RAM) and/or a nonvolatile internal storage, such as read-only memory (ROM) or flash RAM. The memory 820 is an example of computer-readable media.

The computer-readable media may include a permanent or non-permanent type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer-readable media does not include transitory media, such as modulated data signals and carrier waves. For the ease of description, the system is divided into various types of units based on functions, and the units are described separately in the foregoing description. Apparently, the functions of various units may be implemented in one or more software and/or hardware components during an implementation of the present disclosure.

The memory 820 may include program units 822 and program data 824. In implementations, the program units 822 may include one or more of the foregoing units.

One skilled in the art can clearly understand that specific working processes of the system, the apparatus and the units described above may be obtained with reference to corresponding processes in the foregoing method embodiments, and are not repeatedly described herein for the ease and clarity of description.

It should be understood from the foregoing embodiments that, the disclosed system, apparatus and method may be implemented in other manners. For example, the foregoing apparatus embodiment is merely exemplary. The foregoing division of units, for example, is merely a division of logic functions, and other manners of division may exist during an actual implementation. For example, multiple units or components may be combined or may be integrated into another system, or some features may be omitted or not be executed. On the other hand, the displayed or described mutual coupling or direct coupling or communication connection may be indirect coupling or communication connection implemented through certain interfaces, apparatuses or units, and may be in electrical, mechanical or other forms.

The units described as separate components may or may not be physically separated. Components displayed as units may or may not be physical units, and may be located at a same location, or may be distributed among multiple network units. The objective of the solutions of the embodiments may be implemented by selecting some or all of the units thereof according to actual requirements.

In addition, functional units in the embodiments of the present disclosure may be integrated into a single processing unit. Alternatively, each of the units may exist as physically individual entities, or two or more units are integrated into a single unit. The integrated unit may be implemented in a form of hardware, or may be implemented in a form of a software functional unit.

When the integrated unit is implemented in a form of a software functional unit and sold or used as an independent product, the integrated unit may be stored in a computer-readable storage media. Based on such understanding, the essence of technical solutions of the present disclosure, the portion that makes contributions to existing technologies, or all or some of the technical solutions may be embodied in a form of a software product. The computer software product is stored in a storage media, and may include instructions to cause a computing device (which may be a personal computer, a server, a network device, etc.) to perform all or some of the operations of the methods described in the embodiments of the present disclosure. The storage media may include any media that can store program codes, such as a USB flash drive, a removable hard disk, a Read-Only Memory (ROM), a Random Access Memory (RAM), a magnetic disk, or an optical disc.

In summary, the foregoing embodiments are merely provided for describing the technical solutions of the present disclosure, but not intended to limit the present disclosure. Although the present disclosure has been described in detail with reference to the foregoing embodiments, one of ordinary skill in the art should understand that modifications can be made to the technical solutions described in the foregoing embodiments, or equivalent replacements can be made to some technical features in the technical solutions. Such modifications or replacements do not cause the essence of corresponding technical solutions to depart from the spirit and scope of the technical solutions of the embodiments of the present disclosure.

What is claimed is:

1. A method implemented by one or more computing devices, the method comprising:
acquiring an image to be recognized, the image to be recognized having a polygon object;
detecting image information and a position of the polygon object;
projecting the image information of the polygon object onto a recognition area to obtain a projection image based at least in part on the position of the polygon object and a position of the recognition area; and
recognizing the projection image using an image recognition technology to obtain information in the polygon object.

2. The method of claim 1, wherein detecting the position of the polygon object comprises detecting positions of vertices in the polygon object.

3. The method of claim 2, wherein projecting the image information of the polygon object onto the recognition area comprises:
generating a projection matrix from the polygon object to the recognition area, based at least in part on the positions of the vertices in the polygon object and positions of vertices in the recognition area; and
projecting the image information of the polygon object onto the recognition area according to the projection matrix to obtain the projection image.

4. The method of claim 2, wherein detecting the positions of the vertices in the polygon object comprises:
performing edge detection on the image to be recognized to detect edges of the polygon object;
detecting straight edges from the edges of the polygon object; and
determining the positions of the vertices in the polygon object based at least in part on the straight edges.

5. The method of claim 1, wherein, prior to projecting the image information of the polygon object onto the recognition area, the method further comprises:
detecting whether the polygon object is an N-polygon; and
projecting the image information of the polygon object onto the recognition area if affirmative, wherein N is a sum of a number of straight edges of the recognition area.

6. The method of claim 1, wherein the polygon object is an object obtained after an original object is deformed, the projection image is a rectification image of the image to be recognized, the rectification image having the original object after correction.

7. The method of claim 6, wherein recognizing the projection image comprise recognizing the rectification image using the image recognition technology to obtain information in the original object.

8. The method of claim 1, wherein acquiring the image to be recognized comprises:
displaying one or more images to a user, and acquiring an image selected by the user to serve as the image to be recognized from the one or more displayed images; or
acquiring an image collected by an image collection device to serve as the image to be recognized.

9. The method of claim 1, further comprising determining that recognition performed on the image to be recognized using the image recognition technology fails prior to acquiring the image to be recognized.

10. An apparatus comprising:
one or more processors;
memory;
a detection unit stored in the memory and executable by the one or more processors to detect image information and a position of a polygon object included in an image to be recognized;
a projection unit stored in the memory and executable by the one or more processors to project the image information of the polygon object onto the recognition area based at least in part on the position of the polygon object and a position of a recognition area to obtain a projection image; and
a recognition unit stored in the memory and executable by the one or more processors to recognize the projection image using an image recognition technology to obtain information in the polygon object.

11. The apparatus of claim 10, wherein the detection unit is configured to detect positions of vertices of the polygon object.

12. The apparatus of claim 11, wherein the projection unit is configured to generate a projection matrix from the polygon object to the recognition area based at least in part on the positions of the vertices of the polygon object and positions of vertices of the recognition area, and project the image information of the polygon object onto the recognition area according to the projection matrix to obtain the projection image.

13. The apparatus of claim 11, wherein the detection unit is further configured to perform edge detection on the image to be recognized to detect edges of the polygon object, detect straight edges from the edges of the polygon object, and determine the positions of the vertices of the polygon object based at least in part on the straight edges.

14. The apparatus of claim 10, wherein the detection unit is further configured to detect whether the polygon object is an N-polygon, and notify the projection unit to project the image information of the polygon object onto the recognition area if affirmative, wherein N is a sum of a number of straight edges of the recognition area.

15. The apparatus of claim 10, wherein the polygon object is an object after an original object is deformed, the projection image is a rectification image of the image to be recognized, the rectification image having the original object after correction, and wherein the recognition unit is configured to recognize the rectification image using the image recognition technology to obtain information in the original object.

16. The apparatus of claim 10, further comprising an acquisition unit is configured to acquire the image to be recognized, the acquisition unit acquires the image to be recognized by at least one of:
displaying one or more images to a user via a display device, and acquire an image selected by the user to serve as the image to be recognized from the one or more displayed images; or
acquiring an image collected by an image collection device to serve as the image to be recognized.

17. The apparatus of claim 16, further comprising a determination unit configured to determine that recognition performed on the image to be recognized using the image recognition technology fails before the acquisition unit acquires the image to be recognized.

18. One or more computer-readable media storing executable instructions that, when executed by one or more processors, cause the one or more processors to perform acts comprising:
detecting image information and a position of a polygon object included in an image to be recognized;
projecting the image information of the polygon object onto a recognition area to obtain a projection image based at least in part on the position of the polygon object and a position of the recognition area; and
recognizing the projection image using an image recognition technology to obtain information in the polygon object.

19. The one or more computer-readable media of claim 18, wherein detecting the position of the polygon object comprises detecting positions of vertices in the polygon object, and wherein projecting the image information of the polygon object onto the recognition area comprises:
generating a projection matrix from the polygon object to the recognition area, based at least in part on the positions of the vertices in the polygon object and positions of vertices in the recognition area; and
projecting the image information of the polygon object onto the recognition area according to the projection matrix to obtain the projection image.

20. The one or more computer-readable media of claim 18, further comprising acquiring the image to be recognized by at least one of:
displaying one or more images to a user via a display device, and acquire an image selected by the user to serve as the image to be recognized from the one or more displayed images; or
acquiring an image collected by an image collection device to serve as the image to be recognized.
